(19) United States
(12) Patent Application Publication
(10) Pub. No.: US 2020/0312085 A1
(43) Pub. Date: Oct. 1, 2020

(54) Slot-Based Gaming Machine with Player-Selectable Re-Spins

(71) Applicant: Fusion Holdings Limited, Douglas (GB)

(72) Inventors: Hylton David Rottcher, Deerfield Beach, FL (US); Charles Martin Boykin, Deerfield Beach, FL (US); Brendan Clyde Walton, Deerfield Beach, FL (US); Neil Moodaliar, Deerfield Beach, FL (US); David Michael Reynolds, Douglas (GB)

(21) Appl. No.: 16/828,333

(22) Filed: Mar. 24, 2020

(30) Foreign Application Priority Data
Mar. 29, 2019 (GB) 1904479.1

(51) Int. Cl. G07F 17/32

(52) U.S. Cl. CPC G07F 17/3213; G07F 17/34

(57) ABSTRACT

A method includes spinning a plurality of reels. The method further includes determining a plurality of re-spin costs corresponding to a plurality of re-spin combinations. The method additionally includes displaying a first re-spin cost of the plurality of re-spin costs, where the first re-spin cost will result from inclusion of a first reel in a selected combination of reels to re-spin or hold. The method also includes providing an option to include the first reel in the selected combination of reels. The method additionally includes, responsive to receiving input data indicating to include the first reel in the selected combination of reels, displaying a second re-spin cost of the plurality of re-spin costs, where the second re-spin cost will result from inclusion of a second reel in the selected combination of reels. The method also includes, responsive to receiving a re-spinning instruction, re-spinning the selected combination of reels.

### FIELD

The present disclosure relates generally to systems and methods for operating a gaming machine of the type involving spinning reels, and in particular to systems and methods that allow spinning only some reels of the gaming machine.

### BACKGROUND

Wager games come in a variety of forms, including for example a mechanical slot machine. A mechanical slot machine may include one or more reels, each of which includes a fixed pattern of symbols distributed around the circumference of the reel. When a player places a wager (for example, by placing a coin in the machine), the player is allowed to spin the reels. Each reel then comes to rest, typically with either one of the symbols, or a space in between symbols, in alignment with a pay line. A predefined winning symbol or a predefined combination of winning symbols that are aligned with the pay line can result in the player winning the game and receiving a pay-out. In one example, the machine may include three reels, and the pay line may be a horizontal line disposed across a centre of each of the three reels

In another example of a wager game, a mechanical slot machine may present symbols in a matrix arrangement, with each symbol changing during a spin of the game according to the fixed pattern of symbols on the reels. For example, the machine may have five columns and three rows of symbols, for a total of fifteen symbols. Such machines often have multiple pay lines, each being defined by a collection of positions within the matrix. For example, the machine may have three pay lines, each corresponding to one row of the matrix.

While slot machines were traditionally mechanical, modem slot machines often take the form of a video gaming machine (for example, as a dedicated gaming machine located in a casino) that includes a graphical user interface (GUI), and that may emulate a mechanical slot machine. With a video gaming machine, the GUI may display an image of one or more reels or a matrix as described above, together with animation effects to simulate a spin of the one or more reels, or a spin of the columns or rows of the matrix. A computer software program, which may reside in the video gaming machine, may randomly select one or more symbols in response to a spin, and may display the selected one or more symbols on the display.

A modem slot machine may also be played over a computer network, such as by a player using a client machine that is connected to a server machine over the computer network. In this instance, the server machine may perform the spins of the game and may send the resulting symbols to the client machine for display.

### SUMMARY

Viewed from a first aspect, the disclosure provides a computer-implemented method. The method includes spinning a plurality of reels on a display of a machine. Additionally, the method includes determining a plurality of re-spin costs corresponding to a plurality of re-spin combinations, each re-spin combination comprising a subset of the plurality of reels. Further, the method includes displaying, on the display of the machine, a first re-spin cost of the plurality of re-spin costs, wherein the first re-spin cost will result from inclusion of a first reel in a selected combination of reels to re-spin or hold. Still further, the method includes providing, on the display of the machine, an option to include the first reel in the selected combination of reels. Yet further, the method includes, responsive to receiving input data indicating to include the first reel in the selected combination of reels, displaying a second re-spin cost of the plurality of re-spin costs, wherein the second re-spin cost will result from inclusion of a second reel in the selected combination of reels. Further, the method includes, responsive to receiving a re-spinning instruction, re-spinning the selected combination of reels on the display of the machine.

In a second aspect, an article of manufacture may include a non-transitory computer-readable medium, having stored thereon program instructions, that upon execution by at least one processor, cause a computing device to perform the operations of the first aspect.

In a third aspect, a computing device may include at least one processor, a memory component, and program instructions, stored in the memory component, that upon execution by the at least one processor, cause the computing device to perform the operations of the first aspect.

In a fourth aspect, a system may include various means for carrying out the operations of the first aspect.

In a fifth aspect, a computer program may include machine-readable instructions executable to cause a computing device to perform the operations of the first aspect.

In embodiments of the disclosure in which a computer software product is used, the product may be non-transitory and store instructions on physical media such as a DVD, or a solid state drive, or a hard drive. Alternatively, the product may be transitory and in the form of instructions provided over a connection such as a network connection which is linked to a network such as the Internet.

These aspects, as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a simplified block diagram of an example gaming machine, in accordance with example embodiments.

FIG. 2 is a flow diagram in accordance with an example embodiment.

FIG. 3 is a first screenshot of a display screen, in accordance with example embodiments.

FIG. 4 is a second screenshot of a display screen, in accordance with example embodiments.

FIG. 5 is a third screenshot of a display screen, in accordance with example embodiments.

FIG. 6 is a fourth screenshot of a display screen, in accordance with example embodiments.

FIG. 7 is a fifth screenshot of a display screen, in accordance with example embodiments.

FIG. 8 is a sixth screenshot of a display screen, in accordance with example embodiments.

FIG. 9 is a seventh screenshot of a display screen, in accordance with example embodiments.

FIG. 10 is a eighth screenshot of a display screen, in accordance with example embodiments.

FIG. 11 is a first screenshot of an example radio button array, in accordance with example embodiments.

FIG. 12 is a second screenshot of an example radio button array, in accordance with example embodiments.

FIG. 13 is a flowchart, in according with example embodiments.

### DETAILED DESCRIPTION

### I. Introduction

This description describes, among other things, example embodiments including, but not limited to, embodiments pertaining to performing aspects of an outcome event using a machine with an interactive user interface configured to provide rapid response times. The machine can display a variety of symbols on a number of reels during performance of an outcome event. Any one or more of the reels may be individually selected for re-spinning or holding upon user instruction and at a re-spin cost calculated based on an expected outcome resulting from an overall reel position after re-spinning such any one or more reels. As a result of spinning only some reels and holding the other reels in position, the user may be provided with a relative advantage. This relative advantage may be used in calculating the re-spin cost.

By way of example, a user interface may allow a user to re-spin only one, or any combination of reels of a reel-type slot game provided on a gaming machine when the reels are in any position. At the same time, it will be apparent that reels that are not re-spun are held in their current position. Accordingly, embodiments may be provided wherein a user selects which reels are to be re-spun, and embodiments wherein a user may select which reels are to be held. Regardless of the selection made, a reel must either spin or remain in its current condition. The user interface may be configured to inform the user of the cost of selecting a reel for spinning or holding in a timely fashion so that the user experience is not negatively affected by being provided with delayed information.

In an example embodiment, a reel-type slot game may be provided to a user by a gaming machine. Upon receipt of a spin instruction received from the user, all reels of the machine may be spun to provide an initial result when the reels come to rest. The spin instruction may be performed at a bet specified by the user or by the gaming machine. The number of reels may be denoted as N. N may be more than 1. The initial result may be a winning result or not, and a pay-out may be made to the user as applicable in the event of a win. A user may improve their chances of a further win by holding some reels in their current, initial condition, and may alter the position of one or more other reels in order to obtain a more favourable overall reel position, generally a reel position that translates into a win or that activates a bonus feature or game. The goal may be a bigger win than a win that was achieved with the current, initial reel position. Alternatively, the user may reach a specific award which may be to trigger a bonus round or feature game and which requires a specific set of reel positions.

The gaming machine may determine re-spin costs corresponding to different re-spin combinations of reels. In some examples, a re-spin cost may be determined for each possible subset of the N reels. In particular, the machine may calculate the costs of re-spinning each individual reel and also any combination of up to N−1 reels. It will be apparent that for a specific reel combination that is re-spun, the remaining reels will be held in their current condition. The calculation of costs may therefore either be expressed by indicating the reels that are re-spun, or the reels that are held. The resultant costs will be the same, irrespective of the way in which the selection is described. These costs may be based at least on the expected overall reel position after such re-spin or hold and will be further explained below. The calculation may be for re-spinning a combination of up to N−1 reels (and, as explained above, for holding a combination of up to N−1 reels), as re-spinning all N reels, and therefore holding no reels, may be at a bet level which the user may set as for an initial spin.

References in this specification to “spinning only some reels”, “re-spinning some reels”, or similar phrases implies that the remaining reels are held in their current condition and do not spin.

The gaming machine may then display to the user the cost to select and add one or more of the reels of the machine to a selected combination for re-spinning or holding, depending on the implementation of selection. If, for example, the machine includes five reels, a separate cost may be shown to select and add each of the five reels for re-spinning or for holding.

If the user selects any of the reels for re-spinning, the cost to select and add one or more of the remaining reels to a selected combination for re-spinning is then displayed to the user. This cost may be higher, lower, or the same as the cost to re-spin the currently selected reel or reels, but would have already been calculated by the machine. Such cost may replace a cost at which a previous reel was selected and added, or may be added thereto. Similarly, if the user selects any of the reels for holding, the cost to select and add one or more of the remaining reels to a selected combination for holding is then displayed to the user. This cost may be higher, lower, or the same as the cost to hold the currently selected reel or reels, but would have already been calculated by the machine. Such cost may replace a cost at which a previous reel was selected and added, or may be added thereto.

If a user instruction to re-spin a selected reel or reels is received by the gaming machine, the selected reel or reels are re-spun until they come to a rest. The re-spin may occur at the cost previously shown to the user, and the cost shown to the user at a time of selecting and adding the reel or reels for re-spinning is charged for the re-spin.

After re-spinning of the selected reels, the machine may again calculate re-spin costs for re-spin combinations of reels (e.g., the cost to re-spin any of the reels or any combination of up to N−1 reels), and the method may repeat in the same manner as described above.

Advantageously, the systems and methods disclosed herein can allow a display of a machine to provide an interactive user interface with rapid response times to inform a user of a cost to re-spin a reel, which may allow the user to easily make a decision on whether or not to select a reel for re-spinning. Additionally, by allowing a user to select more than one reel, the user interface provides a user with notable freedom in locking the position of some reels, while changing the position of other reels. This may allow a user to progress towards a specific overall reel position. Selecting more than one reel at a time may also allow a user to more quickly progress towards the specific overall reel position than if only a single reel was selected.

Notably, re-spin costs may be pre-determined before a user selects one or more reels to re-spin or hold, allowing the user interface to provide real-time cost updates in response to user selections. In some examples, re-spin costs may be determined as soon as a spin is complete. In other examples, re-spin costs may be computed after a randomized reel position for each reel is determined for a spin, but before animation of the spinning is complete on a display of a computing device. In such examples, re-spin costs may be computed in parallel with the animation. Further, in some examples, a remote server may perform the spins and/or determine re-spin costs before communicating such information to a gaming device over a communication network. Because of potential communication delay, pre-determining re-spin costs for different re-spin combinations may be particularly beneficial in order to provide a responsive user interface in the context of a gaming device which receives information from a remote server in order to operate the user interface.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” with a described list of at least two terms is to indicate any of the listed terms or any combination of the listed terms.

The use of ordinal numbers such as “first,” “second,” “third,” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### II. Example Architecture

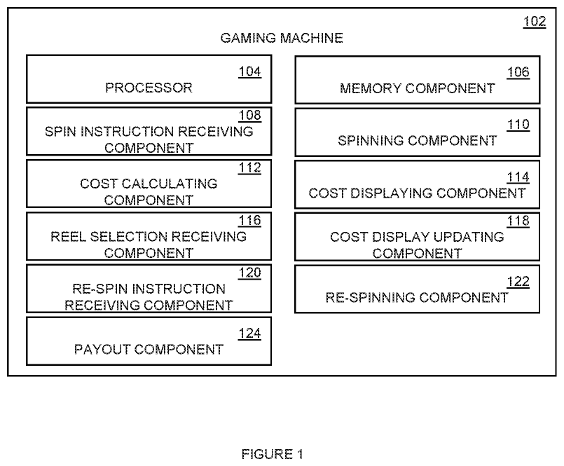

FIG. 1 is a block diagram 100 depicting an example embodiment of a gaming machine 102 arranged to implement operations in accordance with example embodiments described herein. The gaming machine 102 may take any of a variety of forms, including for example a dedicated gaming machine, a personal computer, a server computer, a personal digital assistant, a mobile phone, a tablet device, or some other computing device. The gaming machine may provide a reel-type slot machine with five reels, with each reel including a plurality of symbols.

The gaming machine 102 may be arranged to implement any of the methods as described herein. The gaming machine 102 may include a processor 104 arranged to execute the functions of various components, which may be provided by hardware or by software units executing on the gaming machine 102. The software units may be stored in a memory component 106, and instructions may be provided to the processor 104 to carry out the functionality of the described components. The various components can include a spin instruction receiving component 108, a spinning component 110, a cost calculating component 112, a cost displaying component 114, a reel selection receiving component 116, a cost display updating component 118, a re-spin instruction receiving component 120, a re-spinning component 122, and a pay-out component 124.

The spin instruction receiving component 108 may be arranged to receive a spin instruction from a user, and the spinning component 110 may be arranged to spin the reels of the gaming machine 102 until they come to rest. The spin instruction so received from the user will typically be for spinning all of the reels of the machine, presently five reels.

A random number generating component may form part of the processor 104, and may determine a random stop position for each of the reels upon receiving any spin instruction.

The cost calculating component 112 may be arranged to determine re-spin costs corresponding to different possible re-spin combinations, where each re-spin combination is a subset of the reels. For instance, the cost calculating component 112 may calculate a cost for re-spinning each reel individually, as well as a cost to re-spin any combination of up to N−1 reels of the machine. In the present embodiment's five reels, the cost for re-spinning any combination of up to four reels may be calculated. At the same time that any reel or reels are re-spun, the remaining reels are held in their current condition. The cost to re-spin any combination of 1 to N−1 reels is accordingly the same as if the cost is expressed in a manner that describes which of the remaining N−1 to 1 reels are held.

When considering that there are five reels which may be numbered 1 to 5, the cost may be calculated for selections of reels that may be re-spun, and with corresponding selections of reels that may be held at the same time, as set out in the following table:

| Number of | Possible numbers and | |
|---|---|---|
| reels to | combinations of reels | Corresponding numbers and |
| re-spin: | to re-spin: | combinations of reels to hold: |
| 1 | 1; 2; 3; 4; 5. | 2, 3, 4 and 5; 1, 3, 4 and 5; 1, 2, |
| | | 4 and 5; 1, 2, 3 and 5; 1, 2, 3 |
| | | and 4. |
| 2 | 1 and 2; 1 and 3; 1 and 4; | 3, 4 and 5; 2, 4 and 5; 2, 3 and 5; |
| | 1 and 5; 2 and 3; 2 and 4; | 2, 3 and 4; 1, 4 and 5; 1, 3 and 5; |
| | 2 and 5; 3 and 4; 3 and 5; | 1, 3 and 4; 1, 2 and 5; 1, 2 and 4; |
| | 4 and 5. | 1, 2, and 3. |
| 3 | 1, 2, and 3; 1, 2 and 4; | 4 and 5; 3 and 5; 3 and 4; 2 and 5; |
| | 1, 2 and 5; 1, 3 and 4; | 2 and 4; 2 and 3; 1 and 5; 1 and 4; |
| | 1, 3 and 5; 1, 4 and 5; | 1 and 3; 1 and 2. |
| | 2, 3 and 4; 2, 3 and 5; | |
| | 2, 4 and 5; 3, 4 and 5. | |
| 4 | 1, 2, 3 and 4; 1, 2, 3 | 5; 4; 3; 2; 1. |
| | and 5; 1, 2, 4 and 5; 1, | |
| | 3, 4 and 5; 2, 3, 4 and 5. | |

The cost for the 30 different potential re-spin combinations in the table may therefore be calculated to allow a user to select any reel for re-spinning or any combination of up to N−1 reels as a re-spin combination. The 30 re-spin combinations and calculations have 30 corresponding hold combinations, as set out in the table. The calculated cost may be expected to be the same whether a user selects to re-spin four reels (thereby holding the remaining one in its current position), or whether the user selects to hold only one particular reel (thereby spinning the other four). The relative advantage provided to a user is the same irrespective of how the reels to be re-spun or held are selected by a user. The manner in which the reels are selected for holding or spinning does not impact the relative advantage to the user.

The cost displaying component 114 may be arranged to display the calculated cost to select a reel for re-spinning or holding to a user. The cost may be displayed to add an individual reel at a position on the display so that the cost appears to be associated with a specific reel.

The reel selection receiving component 116 may be arranged to receive, from a user, a selection of a reel to be selected for re-spinning or holding. Then, the cost display updating component 118 may be arranged to update the costs of selecting and adding reels for re-spinning or holding, as applicable. For example, in an embodiment where a user selects reels for re-spinning and in which the user has selected reel 1 for re-spinning, a cost may be displayed at reels 2, 3, 4 and 5 which will be the cost associated with re-spinning any of those reels together with reel 1, which has already been selected for re-spinning. The selection of any additional reel may then add the selected reel for re-spinning and may update the cost payable by the user for re-spinning the selection of reels. The cost may be updated by overriding the previously displayed cost for selecting a reel with the new cost shown in associated with the next selected reel, or may be updated by adding the additional cost associated with selecting the additional reel to the previous cost.

The re-spin instruction receiving component 120 may be arranged to receive a re-spin instruction from the user. The re-spinning component 122 may be arranged to re-spin the combination of one or more reels selected for re-spinning (and hold the reels explicitly selected for holding or to be held by implication) upon such user instruction and at the cost previously calculated and displayed to the user when the one or more reels were selected.

The pay-out component 124 may be arranged to pay a user's winnings according to a pre-determined pay table. The pay table may be influenced by the size of the user's bet or wager for the specific spin or initial spin at which time all of the reels were spun. The pay-out component may pay out a user's winnings after a spin of all reels, or after re-spinning only some of the reels.

### III. Example Operations

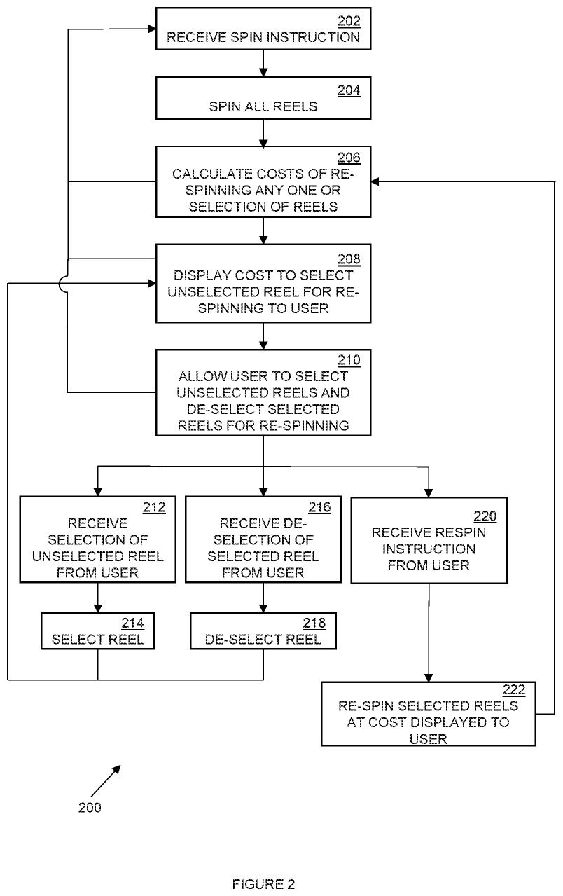

FIG. 2 depicts a flow diagram 200 that illustrates an example method that may be carried out using a gaming machine, such as the gaming machine 102 of FIG. 1. Operations of the method are shown within blocks 202 to 222. The example method can relate to performing outcome events, such as wager games. Any operation described below, or elsewhere in this description, with respect to FIG. 2, can be performed, at least in part, by a processor, such as the processor 104 executing software program instructions. In the embodiment detailed by the present flow diagram (200), a user selects reels for re-spinning, with non-selected reels then held in position upon re-spinning of the selected reels.

Block 202 includes receiving, from a user, a spin instruction. The spin instruction initiates an iteration of the game. The spin instruction may be provided via a dedicated basic spin button, and is an instruction to spin all reels of the gaming machine, presently five reels. The spin instruction may have a bet or wager associated therewith, which the user may be allowed to adjust as desired prior to commencement of the game iteration. The machine itself may also specify the bet or wager. The bet level may affect the potential win size, should the reels come to rest in a position that translates to a win for the user. Responsive to receiving such a spin instruction, block 204 includes spinning all the reels of the gaming machine, presently five reels. The reels then come to rest at positions determined by a random number generator associated with the gaming machine.

The reels may come to rest in a position that results in a win to the user or in a position that does not result in a win. Should the reels be in a win position, the user may receive a corresponding pay-out according to their bet level and a pay table associated with the gaming machine.

Block 206 includes calculating the costs of re-spinning any reel individually, as well as the cost to re-spin any combination of up to N−1 reels, presently combinations of up to four reels for the five reel slot game. Potential combinations of reels that may be selected for re-spinning may include, for the present embodiment where the gaming machine 102 includes five reels, all combinations of two, three or four reels, and also the individual reels.

The cost for re-spinning any reel, or any combination of reels, may be expected to be based on a variety of factors. These may include, but are not limited to, the user's bet or wager size, the size of a possible win based on the specific combination of reels that may be selected for re-spinning, the likelihood of winning based on re-spinning the reels, any win that is assured if only certain reels are re-spun, any multipliers that are removed from a pay line, and the like. An assured win may arise, for example, if a number of symbols on a pay line has resulted in a win, and a user re-spins only some of the reels, while leaving sufficient symbols on the pay line that will still lead to a win irrespective of the outcome of the re-spun reel or reels. It will be apparent that many additional factors may be taken into account and may influence the cost. Different types of slot games may also include different features that may need to be considered in determining the cost of re-spinning a reel or combinations of reels.

In some examples, determining a re-spin cost may involve simulating multiple possible resulting reel positions for a given re-spin combination of reels. A re-spin cost may then be determined as an expected outcome by calculating an unweighted average or a weighted average of expected results from each of the possible resulting reel positions. For instance, 10's, 100's, or 1,000's of possible outcomes may be simulated in order to determine a re-spin cost.

Block 208 includes displaying the calculated cost to select any unselected reel for re-spinning to a user. The calculated cost may be displayed so that it indicates its association with the specific reel that may be selected for re-spinning.

Block 210 includes allowing a user to select any unselected reel for re-spinning, and also to de-select any selected reel. It will be apparent that where no reels have yet been selected by a user, the option to de-select a selected reel may not yet be available to the user. Furthermore, if the user has selected one less reel than the total number of reels, presently four reels, the user may not be allowed to select the only remaining reel. Only de-selection of any selected reel may then be available to the user. To re-spin all reels, a main spin or bet button may need to be selected to initiate a further iteration of the game. However, it is envisaged that some embodiments may allow selection of all reels, in which case the cost to re-spin all reels may simply carry the cost of a normal spin, which will spin all reels as in blocks 202 and 204.

At this stage at block 210, four different routes may be followed by the method. The first route may be initiated when a user provides another general spin instruction. The method will then move back to block 202, where a spin instruction is received from the user. The user may follow this route if they are not interested in holding some reels in position and re-spinning others, but want to spin all reels.

It should be noted that the user may provide such other general spin instructions during the progress of block 206 with calculation of costs, and at block 208 during the display of costs to a user. In practice, however, the step in block 206 will ideally be performed rapidly and blocks 208 and 210 will follow almost immediately upon block 206 and at substantially the same time. From a gameplay perspective, it may be preferred that the calculation of costs in block 206 be performed as speedily as possible such that blocks 208 and 210 appear to be performed almost simultaneously. Nevertheless, in so much as the steps in blocks 206 and 208 take a finite time to be executed prior to the step in block 210, a general spinning instruction may be provided during such execution as well and the method may then return back to block 202. All of the re-spin costs calculated in block 206 may be determined before proceeding to block 208 to ensure that the necessary information is available to provide a responsive user interface in response to user selections.

The second route, at block 212, may include receiving a user selection of an unselected reel that is to be added for re-spinning. If such a user selection has been received, block 214 may include selecting the reel. Then, the method may return to block 208, and the display may be updated so that the cost to select and add any remaining, unselected reel, may be displayed to a user, with the restriction that a cost to select all reels may not be provided as explained with reference to block 210 above. If one less than the total number of reels are selected, no further selections may be possible and no cost may be displayed to select a final unselected reel.

The third route commences at block 216 and includes receiving, from the user, a de-selection of a reel that has been previously selected. Again, this route may only be followed if at least one reel has previously been selected. If such a selection is received, the reel is de-selected at block 218. The method again moves back to block 208 and the cost to select any unselected reel for re-spinning is displayed to the user.

The fourth route starts at block 220. If any reel is selected for re-spinning, a user may provide a re-spinning instruction. Block 220 includes receiving such re-spinning instruction from the user. Block 222 then includes re-spinning the selected reels. The reels are then re-spun at the cost displayed to the user when any reels were selected for re-spinning.

When the re-spun reels come to a stop, the method may move back to block 206, which includes calculating the cost to re-spin any one or any selection of the reels, up to N−1 reels.

It should be noted that in order for a user to spin all of the reels, and not simply re-spin a selection thereof, the user may provide a basic spin instruction similar to that which initiated the method at block 202, thereby initiating a further iteration of the game. A dedicated basic spin button may be provided for such an action; however, a user may be allowed to adjust their bet level before such instruction is provided. This instruction may be similar to the operation of a standard reel-type game. The user may be allowed to select this option at any stage, and not just after a re-spin action. For example, all the reels of the machine may be spun by a user at any time between blocks 206 and 222 and may be expected to override and ignore any selection of reels for re-spinning. A user may, for example, change their mind after selecting one or more reels for re-spinning, and simply press the basic spin or bet button to spin all reels and re-start the method at block 202.

Any of the blocks of a flow diagram or a component in a block diagram may be provided by hardware or by software associated with the specific electronic device, whether the multimedia computer, user's mobile device, or any server. These electronic devices may be embodied by a personal computer, laptop computer, personal digital assistant, smartphone, feature phone, satellite phone, server computer, phablet, tablet, wearable computer, or the like. Appropriate components may form part of such device for the operation of the required method on that device. Further, the electronic devices may be configured to communicate wirelessly or over a wired communication network. The various components forming part of each electronic device may be configured to communicate with each other via an appropriate communication interface, while an appropriate external communication interface may facilitate communication with other electronic devices, whether forming part of the present systems or not.

Notably, the feature of calculating the costs for all possible re-spinning selections immediately upon the reels coming to a rest and displaying to a user the cost to add any unselected reel for re-spinning allows a user to make informed decisions before selecting a reel for re-spinning. Additionally, in some examples, re-spin costs may be determined in parallel with animating reel spinning after an ending randomized reel position for each reel has been determined but not yet displayed in order to provide a responsive user interface. In addition, calculations may occur only once after any spin so that re-calculating the costs after each selection or deselection is not required. Only the display of such costs may need to be updated. This may speed up a user's play and may lead to a more responsive playing experience.

Additionally, the processing capabilities of the gaming machine may only be needed after each spin event, which may prevent continuous use thereof after each selection or de-selection action.

Furthermore, in examples where the re-spin costs are determined by a server remote from the gaming machine, continuous network communication after each selection or de-selection action may be avoided.

By providing a user with the option to incrementally select more than one reel for re-spinning, the playing and modification options provided by the user interface to a user may be enhanced. By allowing the selection of individual or multiple reels for re-spinning, the user interface may allow a user to incrementally build up a reel position to obtain a win or to reach a bonus round. Allowing selection of multiple reels for re-spinning may allow a user to more quickly build up the overall reel position than if only a single reel was selectable. This may allow a user to seek a particular game feature, for example a particular bonus feature or feature game.

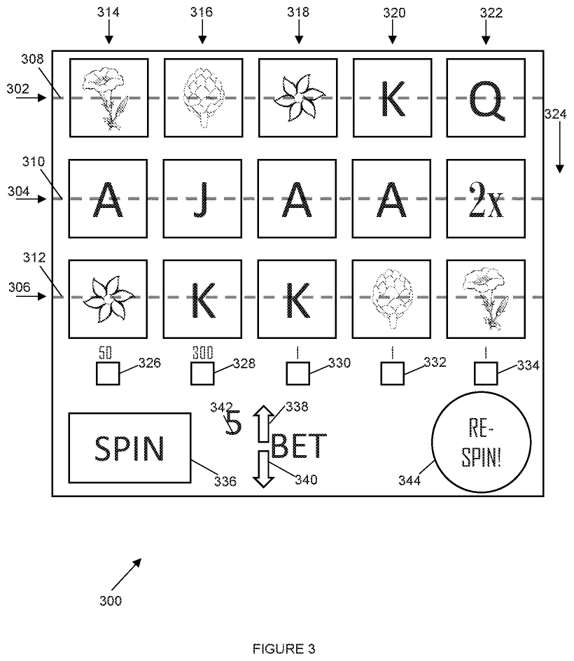

FIGS. 3 to 10 depict screen shots of a gaming machine display (300) showing a graphical user interface (GUI) on which a game according to an example embodiment is played. Like reference numerals on FIGS. 3 to 10 represent like features and components. This example embodiment again shows an embodiment wherein a user selects reels for re-spinning, with the implication that unselected reels are, effectively, selected for holding similar to the embodiment described with reference to FIG. 2 above.

FIG. 3 shows the display (300) after an initial spin of all reels. The example game of the present embodiment is a five reel slot game, having three pay lines. Three symbols of each reel are shown at a time, forming a matrix-like display. A pay line is provided on each row of the matrix, and the reels form the columns of the matrix. The three rows are numbered 302, 304 and 306, and pay lines 308, 310 and 312 are associated with rows 302, 304 and 306, respectively.

Reel one and column one is indicated by numeral 314, reel two and column two by numeral 316, reel three and column three by numeral 318, reel four and column four by numeral 320, and reel five and column five by numeral 322.

A spinning direction of the reels is shown by a directional arrow 324.

Each reel (314, 316, 318, 320, 322) has a corresponding tick box (326, 328, 330, 332, 334) provided underneath each respective reel and column. In the present embodiment, each tick box allows a user to select the corresponding reel for re-spinning. A cost to include the specific reel in a selected combination of reels for re-spinning is shown above each reel's tick box and has already been calculated by the gaming machine upon completion of a spin or at the time that the randomized reel position became known. As explained above with reference to FIG. 2, the cost to re-spin any selected combination of reels up to N−1 reels was calculated at the same time.

A primary spin button 336 is provided which may be selected by a user to provide a spin instruction and spin all of the reels at the same time. Selecting this button may initiate the method of FIG. 2. A first arrow button 338 allows a user to increase the size of a bet on a game, possibly to a maximum level, and a second arrow button 340 allows a user to reduce the size of the user's bet. The bet level 342 is also shown to a user and is currently 5 credits.

A re-spin button 344 is provided and selection thereof may cause re-spinning of selected reels.

The buttons may be physical buttons associated with the gaming machine or may be provided on a touch-sensitive display screen, where the buttons may be selected by a user. Alternatively, a pointing device such as a computer mouse may be used to select the buttons when applicable.

The symbol arrangement shown in FIG. 3 did not lead to a win for the user. For a win to occur in the present game, three or more of the same symbol must appear on a pay line starting from the first reel 314, that is, the same symbol must appear on the first reel 314, the second reel 316, and on the third reel 318. Another one of the same symbol on the fourth reel 320 will increase the win, and a further symbol on the fifth reel 322 will increase the win even further. The size of the win is generally detailed in a pay table that may be available to a user to view. Generally, different symbols may lead to different win sizes, generally as a percentage or multiple of the bet made by the user. Four symbols will lead to a bigger win than three symbols, and five symbols to an even bigger win. Of course, the chance of landing three identical adjacent symbols on a pay line is much greater than the chance of landing four symbols in order on a pay line. Similarly, the chance of landing five symbols in order on a pay line is even smaller.

In FIG. 3, none of the pay lines show a winning symbol arrangement. However, on the second pay line 310, an Ace, denoted by an “A”, appears on the first reel 314, the third reel 318, and the fourth reel 320. A wild multiplier, denoted by a “2×” symbol, appears on the second pay line 310 and on the fifth reel 322.

The wild multiplier substitutes for any symbol which is required for a win and also doubles the value of the win as per the applicable pay table, should it be used to substitute for any symbol in a win. Accordingly, it currently substitutes for another Ace. Only the second reel 316 does not have an Ace on the second pay line 310. The cost to re-spin the second reel 316 to attempt to also obtain an Ace on the second pay line 310 is therefore high, as the chance of landing a single Ace on a pay line is significantly higher the chances of Aces landing on each reel and on the same pay line if all reels were re-spun. The chance of a user obtaining a large win is accordingly higher than if all reels were re-spun, and the cost to re-spin the only reel without an Ace reflects the user's higher chance of obtaining a big win. The relative advantage to the user influences the cost of the re-spin of only the second reel. The cost is provided above the second tick box 328 and is shown as 300 credits. This is notably higher than the initial bet of 5 credits, but for the reason outlined above.

Also in FIG. 3, a King, denoted by the “K” symbol, appears on the third pay line 312 and on both the second reel 316 and the third reel 318. While this also does not lead to a win, a additional King landing on the third pay line 306 and on the first reel 314 would lead to a win. The cost to re-spin only the first reel is shown as 50 credits to reflect both the fact of the increased likelihood of a win if only the first reel 314 is re-spun, while also taking into account the fact that three Kings will lead to a smaller win than, for example, five Aces with a 2 times multiplier on the second pay line 310 as described above.

The first pay line 308 in FIG. 3 has no symbol combination of interest that may affect the cost to select a reel for re-spinning.

The cost to re-spin the third reel 318, the fourth reel 320, or the fifth reel 322 is shown as 1 credit, as re-spinning any of them on their own cannot lead to a win with the reels in their current positions.

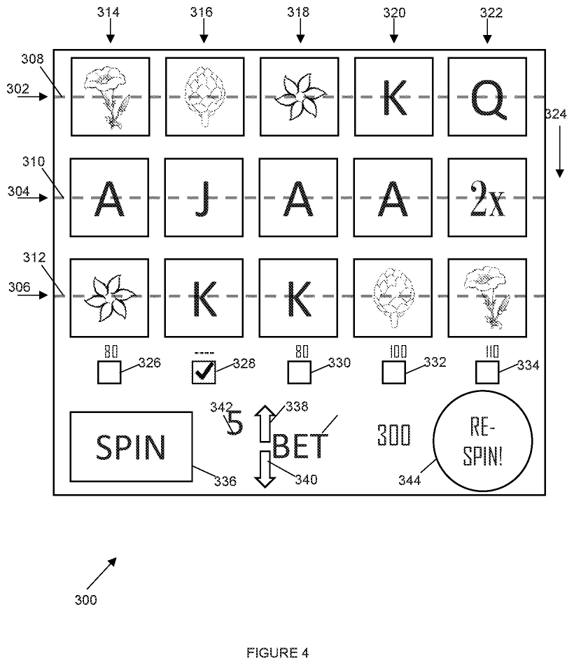

The user may now select the second tick box 328 in order to select and add the second reel for re-spinning. Turning now to FIG. 4, a tick is shown in the second tick box 328 showing that it has been successfully selected by the user. The cost of 300 credits to re-spin the second reel is displayed next to the re-spin button 344 and will be charged if the user selects the re-spin button 344.

The cost to select and add any other reel to a selected combination of reels for re-spinning is updated and again displayed to the user above the relevant tick boxes. It should be noted that in the present embodiment, the cost to select and add another reel for re-spinning will override the 300 credit cost already shown. In FIG. 4, the cost to select and add the first reel 314 or third reel 318 for re-spinning is shown to be 80 credits each. If either one of these two reels is also selected, the cost to re-spin that reel together with the already selected second reel 316 will be 80 credits. This reflects the change to the relative advantage to the user in that there will be a reduced likelihood of an Ace, or a wild symbol substituting for an Ace, landing on the second pay line 310 of both the second reel 316 and any such selected reel to be re-spun at the same time. The fact that the third reel 318, fourth reel 320 and fifth reel 322 already contain an Ace or a symbol substituting for an Ace in the second pay line 310 is taken into account at a time of calculating the cost to re-spin any of the first reel 314 or the third reel 318 with the second reel 316.

The cost to select and add the fourth reel 320 for re-spinning is shown to be 100 credits—If an Ace or a symbol substituting for an Ace lands on the second pay line 310 and the second reel 316, but not on the fourth reel 320, the user will still win something as three sequential symbols will appear on the second pay line 310 on the first reel 314, the second reel 316 and the third reel 318. The chance of an Ace landing on the second pay line 310 and on the second reel 316, but not on the fourth reel 320 is higher than an Ace landing on both the second reel 316 and the fourth reel 320 on the same pay line, which would lead to a win for the user. As a result, the cost to re-spin the fourth reel 320 with the second reel 316 is higher than the cost to re-spin the first reel 314 or the third reel 318 with the second reel.

The cost to select and add the fifth reel 322 for re-spinning with the second reel 316 is shown to be 110 credits. If an Ace lands on the second pay line 310 and on the second reel 316, but not on the fifth reel 322, the user will still win as there will then be four sequential Aces on the second pay line 310. There is still a chance that an Ace or a symbol substituting for an Ace lands on the fifth reel. In the present embodiment the chance of a two times multiplier wild again landing on the second pay line 310 on the fifth reel 322 is lower than an Ace landing thereon. The cost to re-spin the fifth reel 322 may take this into account and may be lower than expected compared to the cost of re-spinning the fourth reel 320.

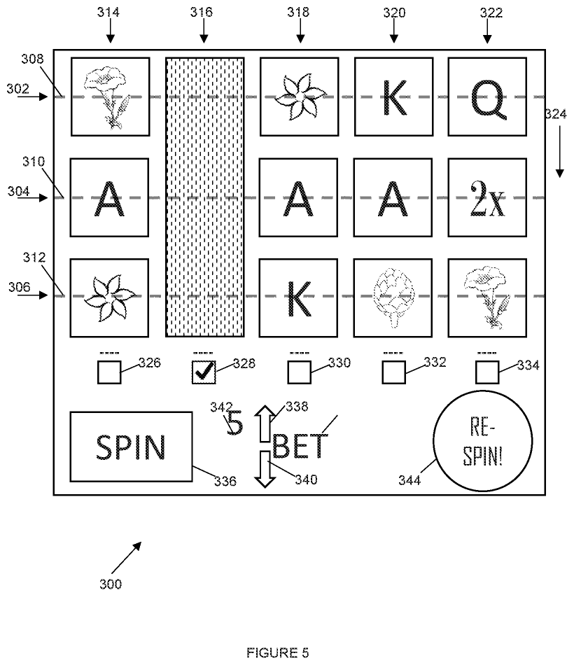

Moving now to FIG. 5, the user has selected the re-spin button 344 with only the second reel 316 selected. The second reel 316 is re-spun at the cost of 300 credits, and spins in the direction of the directional arrow 324. Upon selecting the re-spin button, the 300 credits are deducted from the user's balance. As the second reel 316 is spinning, the other reels are held in place and remain in their previous state.

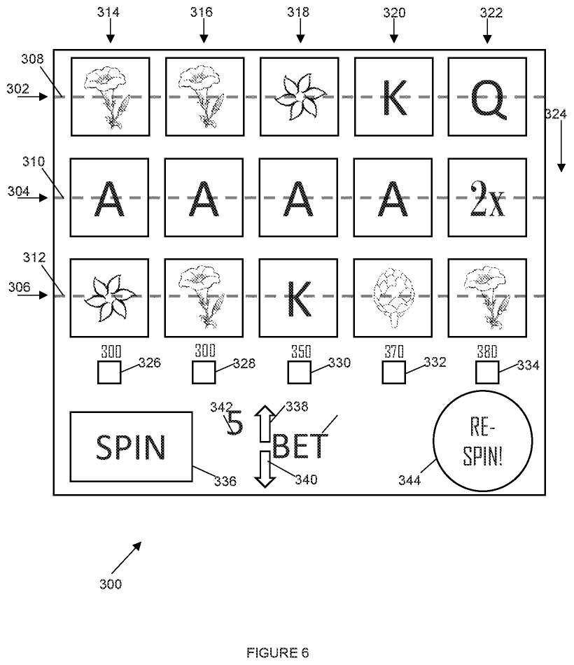

Moving then to FIG. 6, the second reel 316 has now stopped, with an Ace on the second pay line 310. There are now four Aces and one two times multiplier on the second pay line 310, which results in a big win for the user. The win may be expected to be more than the 300 credits that the user paid for the re-spin of the second reel 316, otherwise it would of course not have made sense to pay to re-spin the reel. The user may now again choose any one of the reels, or any combination of reels, to select and add for re-spinning. Again, the cost to re-spin any reel, and any combination of reels up to four reels, have been calculated when the reel positions became known, and these costs may be displayed to the user when applicable.

The cost to re-spin the first reel 314 and the second reel 316 is shown as 300 credits—the same cost as shown in relation to the second reel in FIG. 3. This is because the likelihood of landing an Ace or a wild symbol substituting for an Ace on the second pay line 310 on those reels remain the same.

The cost to select and add the third reel 318 for re-spinning is shown to be 350 credits. The chance of an Ace landing on the second pay line 310 and on the third reel 318 is the same as for the first reel 314 and the second reel 316. However, it should be noted that the same flower has landed on the first pay line 308 and on the first reel 314 and the second reel 316. As a result, there is a chance that this same flower, or a wild symbol substituting for this flower, may land on the first pay line 308 and on the third reel 318 as well, should only the third reel 318 be re-spun. The user therefore has a chance of winning on both the first pay line 308 and the second pay line 310 when they re-spin the third reel 318. As a result, the cost to re-spin only the third reel 318 is higher than the cost of re-spinning only the first reel 314 or the second reel 316.

The cost to select and add only the fourth reel 320 is shown to be 370 credits. The user has the same chance of landing an Ace or a wild symbol substituting for an Ace on the fourth reel, however, the user is assured of a win if only the fourth reel 320 is re-spun. The first three reels already include an Ace on the second pay line 310 and as a result, even if another Ace does not land on the second pay line 310 on the fourth reel 320, the user will still have three symbols on the second pay line 310 and will receive a win.

The cost to re-spin the fifth pay line is shown as 380 credits. As with re-spinning the fourth reel 320, re-spinning only the fifth reel will still result in a reel as there will still be four Aces on the second pay line starting from the first reel 314. It should be noted that the fifth reel currently includes a two times multiplier wild on the second pay line 310 which substitutes for an Ace. The chance of a multiplier landing again may be smaller than the chance of an Ace landing, which may influence the cost as the winning if an Ace lands will be half that than if a two times Multiplier wild lands.

For illustrative purposes, another feature of the present game may be that if any of the three pay lines are filled with five of the same type of flower symbols, a bonus game is activated which may award free spins of the game to a user.

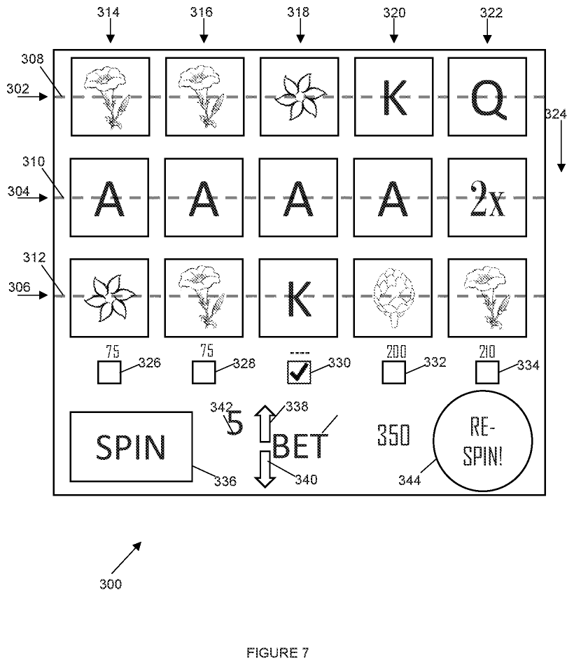

Moving now to FIG. 7, the user may try to obtain five of the same flowers on a pay line in order to access the bonus game. The first reel 314 and the second reel 316 have the same flower on the first pay line 318, and the user may have a better chance of filling the whole first pay line 308 with that same flower than if they were to re-spin all of the reels at the same time. The cost of re-spinning the third reel 318, fourth reel 320 and fifth reel 322 reflects this higher chance.

FIG. 7 shows the user to have selected the third check box 330 associated with the third reel 318 to select and add it for re-spinning. The cost of re-spinning the selected reel, as displayed next to the re-spin button 344, is displayed as 350 credits, and the individual costs of selecting and adding any other reel to the user has been updated above the applicable tick boxes and are also displayed to the user.

The cost to add and select either the first reel or the second reel is shown as 75 credits—if any of these two reels are selected, the user has a lower chance of winning than if only the third reel 318 is re-spun, and the cost is accordingly lower than if only the third reel 318 is re-spun. Again, the fact that an Ace or a symbol substituting for an Ace may land on the second pay line 310 to provide a big win, as a result of the third reel 318, fourth reel 320 and fifth reel 322 already having an Ace or a symbol substituting for an Ace on the second pay line 310, will influence the cost associated with the re-spins. However, re-spinning the first reel 314 or second reel 316 with the third reel 318 will lower the chance of a win on the first pay line by three flowers landing on the first pay line 308, and this will also be taken into account upon calculating the cost to select and add either the first reel 314 or the second reel 316 for re-spinning.

The cost to add and select the fourth reel 320 for re-spinning with the third reel 318 is shown as 200 credits. The chance of landing all Aces on the second pay line 310 is reduced if two reels are selected for re-spinning, and therefore the cost is lower than the cost for only re-spinning the third reel 318. The cost to add and select the fifth reel 322 for re-spinning with the third reel 318 is shown as 210 credits. Again, the chance to land an Ace or a symbol substituting for an Ace on the second pay line 310 and on both the third reel 318 and the third pay line is less than only landing it on one such reel. However, if it only lands on the third pay line there will already be a win for the user as the first four reels will then have an Ace thereon. This of course influences the cost for re-spinning the third reel 318 with the fourth reel 320 or the fifth reel 322. It should be noted that the two times multiplier wild will be removed from the second pay line 310 on the fifth reel 322 when the fifth reel 322 is re-spun, with the chance of it landing again being smaller than an Ace landing. This is factored into the cost to add the fifth reel 322 for re-spinning.

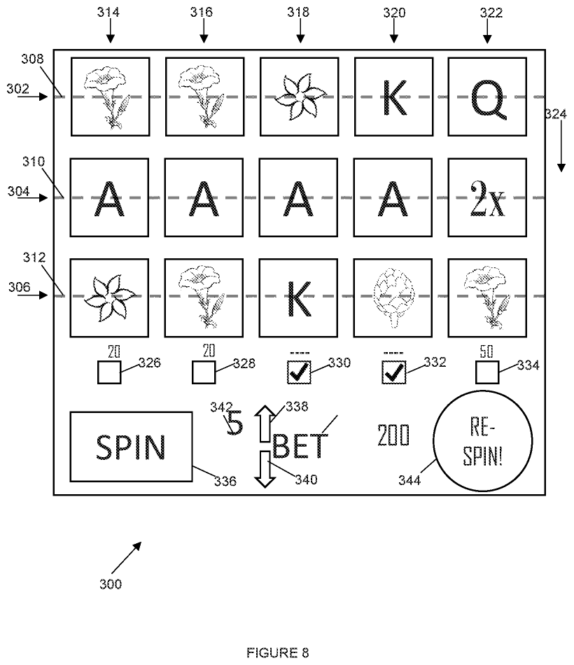

Moving now to FIG. 8, the user has also selected and added the fourth reel 320 for re-spinning. The cost of re-spinning the selected reels, as displayed next to the re-spin button 344, has been updated to 200 credits, and the individual costs of selecting and adding any other reel to the user has been updated and is displayed to the user above the applicable tick boxes.

To select either the first reel 314 or the second reel 316 for re-spinning is shown to be 20 credits—if either of those are selected with the third reel 318 and the fourth reel 320, the chance of the user winning will be reduced. To also select and add the fifth reel for re-spinning is shown to cost only 50 credits as it reduces the potential size of a win, particularly on the second pay line 310 where a two times multiplier will be removed. Selecting the fifth reel 322 as well will, however, allow the possibility of obtaining all of the same type of flower on the first pay line 308 and all Aces on the second pay line 310.

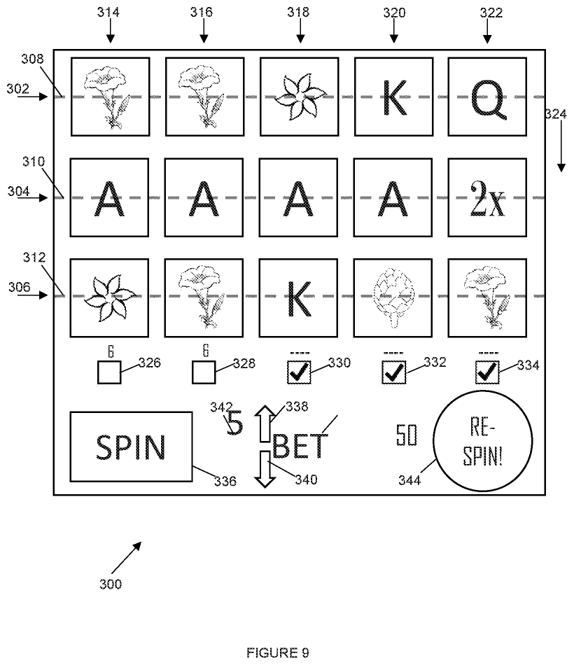

Moving now to FIG. 9, the user has now also selected the fifth reel 322 for re-spinning to try and obtain five of the same flowers on the first pay line 308. The cost of re-spinning the selected reels, as displayed next to the re-spin button 344 has been updated to 50 credits, and the cost of selecting and adding any other reel as displayed to the user has been updated above the applicable tick boxes. The cost to add the first or the second reel for re-spinning is shown to be 6 credits as also selecting such reels will further reduce the user's chance of winning as the matching symbols on the first two reels 314 and 316 will be removed. If any of these reels are selected the user's chances of winning is similar to if all five reels are re-spun.

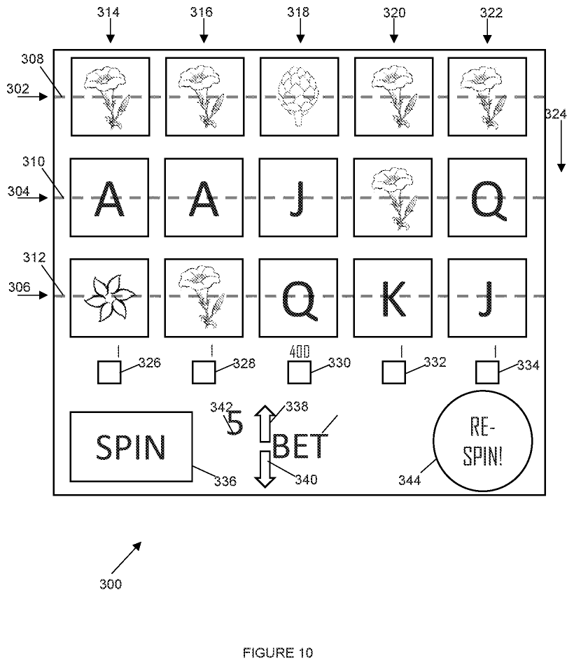

Moving then to FIG. 10, the user has selected the re-spin button 344 of FIG. 9, and the third reel 318, fourth reel 320, and fifth reel 322 have come to a stop in new positions as shown. The resulting overall reel position in FIG. 10 did not lead to a win for the user—the same symbol does not appear on any pay line on the first reel 314 to the third reel 318. However, it should be noted that on the first pay line 314, the same flower that was previously on only the first reel 314 and second reel 316 has now also landed on the fourth reel 320 and the fifth reel 322. The user may re-spin only the third reel 318 to again try and fill the first pay line 308 with the same flower so that they may receive an appropriate award, presently a bonus round with free spins. Also, the first reel 314 and second reel 316 also include an Ace symbol on the second pay line 304, and the user has a further chance to win if the third reel 318 lands again lands an Ace on the second pay line, which is factored into the cost for re-spinning the third reel 318 on its own.

The cost to select and add only the third reel 318 for re-spinning is now shown to be 400 credits. The likelihood of obtaining a win on both the first pay line 308 and the second pay line 310 is taken into account in determining this cost. By re-spinning only the third reel 318, the user may have a relatively high chance to reach the bonus round by completing a full first pay line 308 of the same type of flower and may obtain three Aces on the second pay line 310 for a win.

The cost to select the first reel 314, the second reel 316, the fourth reel 320 or the fifth reel 322 is shown as 1 credit. Re-spinning any of these reels on their own may actually leave the user in a less-favourable position, and this is taken into account in calculating such re-spin costs. For example, re-spinning only the fourth or fifth reel, or even the fourth and fifth reel together cannot result in a win as a win requires symbols on the first three reels to line up in the present embodiment. This fact may contribute to the low cost of selecting and adding such reels for re-spinning. It should, however, be noted that as soon as any reel is selected for re-spinning, the cost to add and select any other reel will be updated and may be higher or lower than an amount that appears in FIG. 10.

The embodiment described with reference to FIGS. 3 to 10 is merely an example, and other implementations of the present disclosure may involve simpler or more complex calculations to obtain a cost for every possible re-spin combination. As an example, some gaming slot machines include a single pay line and the considerations to calculate costs for the re-spinning of individual reels may accordingly be simpler than that of the example above. Some five reel gaming slot machines include 243 pay lines, and it will be apparent that the considerations for calculations required to determine a cost for a re-spin may be significantly more complex than that described above. Furthermore, many different aspects may be included as part of a game, for example scatter symbols that may result in a win or bonus round, payment on a pay line from both the first to the last reel and from the last to the first reel (left to right and right to left), progressive wins, more or less reels, more or less pay lines, a user's bet level, whether all or only certain pay lines are active, and the like. There a many different types of game features that may influence a cost of a re-spin and those provided above are merely given as examples.

When a reel is selected, the reel may be highlighted in some format to the user so that its selection is clear. This may operate in combination with the tick boxes described above with reference to FIGS. 3 to 10.

For illustrative purposes, the costs for re-spins were specifically chosen as integer numbers, however, proper calculation of re-spin costs may lead to non-integer numbers costs. A game may be played with credits, tokens, monetary currency or the like, and where a basic spinning cost is a monetary value, for example $1, a re-spin cost may include cents or the like as appropriate. In some embodiments, tokens or credits may be earned during gameplay that may be used to purchase a re-spin. Such tokens may not be directly related to a basic spinning cost—although a user may be awarded a certain number of such tokens or credits based on their bet for a basic spin at a time of being awarded with such credits or tokens during gameplay.

It will be apparent that a user's account balance will be checked before any spin, or re-spin, is initiated. Re-spinning or spinning may not be possible if insufficient credits are held in a user account. If, for example, a re-spin costs 400 credits, but a user's balance is only 300 credits, they may of course not be able to re-spin such a reel, or even be allowed to select such reel. If a user's balance is too low to select a reel for re-spinning, the tick box may be greyed out as applicable, or the re-spin button may be greyed out if such reel is selected. A user may then be allowed to or prompted to purchase additional credits to proceed.

While the embodiment described with reference to FIGS. 2 to 10 above allows selection of a reel for re-spinning, other embodiments may allow reels to be selected for holding instead. Such embodiments may provide an appearance of a “pay to hold” playing experience instead of a “pay to re-spin” playing experience. This may be perceived differently to a player, however, the underlying mathematics used for cost calculation may be identical, as explained above. For such “pay to hold” embodiments, tick boxes may be provided and may be associated with each reel to select such reel for holding. The costs to hold, for example, two reels, may be expected to be the same as the cost for re-spinning the other three reels, as the relative advantage to the player remains the same. This is also illustrated in the table provided above. Some embodiments may allow a user to select the format in which the selection of reels is offered to a user, i.e. a “pay to re-spin” selection, or a “pay to hold” selection.

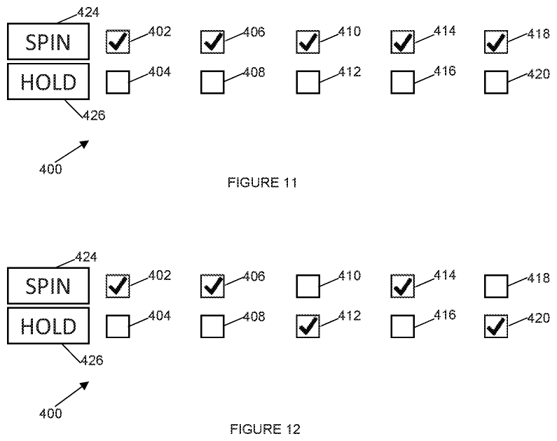

FIG. 11 shows a radio button array (400) that may form part of a user interface of a reel-based slot game according to an example embodiment. For each reel, a selectable option may be provided to include the reel within a selected combination of reels. Together, the options may make up a radio button array. Five pairs of check boxes (402, 404; 406, 408; 410, 412; 414, 416; and 418, 420) are provided next to each other. In the user interface, each pair of check boxes will be associated with a specific reel of the reel-based slot game. Upper tick boxes (402, 406, 410, 414, 418) of the pairs are associated with a “SPIN” label (424) that appears next to them, and lower tick boxes (404, 408, 412, 416, 420) are associated with a “HOLD” label (426) that appears next to them.

After a spin of any one or more reels, all of the tick boxes associated with the SPIN label may be selected by default, as is shown in FIG. 11. This may indicate to a user that by default, all reels will be spun if a spin action is initiated, for example by selecting a spin button. Should a user select some reels to hold in their current position whilst re-spinning only some other reels, they may select the tick boxes associated with the HOLD label (426) and the reels of their choosing.

In FIG. 12, the HOLD tick box (412) associated with a third reel and the HOLD tick box (420) associated with a fifth reel have been selected by the user. The previous ticks in the corresponding SPIN tick boxes (410, 418) are no longer shown. This is because selection of a specific tick box removes the tick in the other of its pair—a reel must either be selected for re-spinning, or for holding. These actions are opposites of each other and cannot be selected at the same time, however, one of them must be selected. The pair of tick boxes acts similar to a toggle switch, and may in fact be represented by such a switch.

With the tick boxes selected as shown in FIG. 12, the user may select an appropriate “Spin” button, and the first, second and fourth tick boxes, which are selected for re-spinning, will spin while the third and fifth reels will be held in their current conditions. It should be noted that in this embodiment, a “re-spin” button need not be provided, but a general “Spin” button may spin the reels according to the selection of tick boxes.

It will be appreciated that any suitable method of showing a cost associated with holding or re-spinning a reel to a user may be employed. In the present embodiment, the default is that all reels are selected for spinning as per FIG. 11. As a result, a cost may be shown in relation to a reel and which may be charged for changing the selection of a reel for spinning, to holding. This may also provide the appearance of a “pay to hold” embodiment.

By re-spinning individual or multiple reels (and thereby holding the other reels in their current conditions), a user may build up the overall reel positions to obtain a win or to reach a bonus round. This may allow a user to seek a particular game feature, for example a particular bonus feature or feature game that requires a specific reel position. By automatically calculating the cost to re-spin individual reels as well as combinations of reels, and displaying such costs to a user before the user selects and adds reels for re-spinning or holding, the user interface promptly informs the user of the cost for re-spinning reels.

In some embodiments, a user may be provided with suggested combinations of reels to re-spin or hold. If, for example, two reels may be re-spun to result in a big win or bonus round, such reels may be highlighted to a user. A cost associated with selecting such two reels may be displayed to a user, possibly in a location more prominent than the cost associated with adding a single reel and possibly so that the two reels that are selected are clearly shown to the user. An appropriate selection by the user may then lead to both applicable reels being selected at the same time, with the cost to select other reels still being updated as normal. A user may also be allowed to enable automatic selection of reels that, when re-spun or held, as the case may be for the particular embodiment, may lead to a notable win or the like.

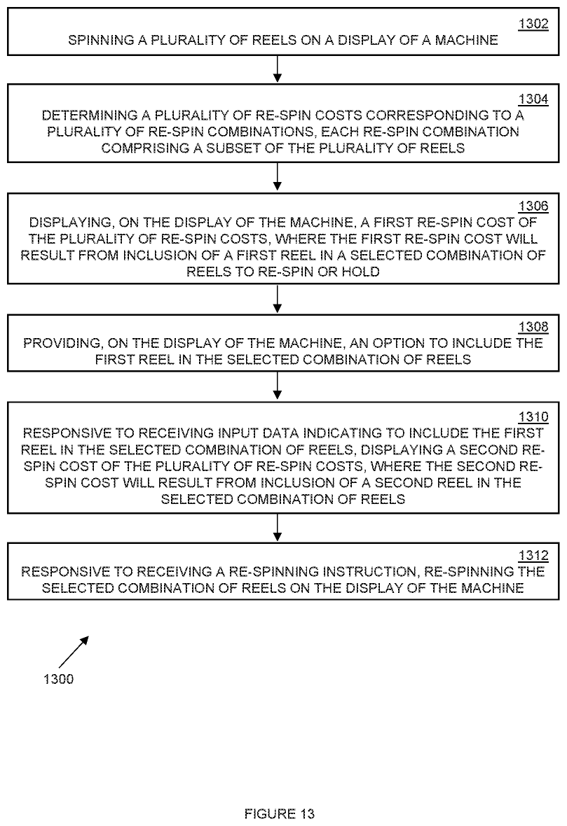

FIG. 13 depicts a flowchart showing operations of a method 1300 that can, for example, be carried out using gaming machine 102. In other examples, the operations of method 1300 could be carried out by a different computing device with a display. Additionally, certain aspects of method 1300 could also be carried out by a remote server as well. Furthermore, it is noted that the functionality described in connection with the flowchart can be implemented as special-function and/or configured general-function hardware modules, a computer program or portions of program code executed by a processor for achieving specific logical functions, determinations, and/or steps described in connection with the flowchart shown in FIG. 13. Where used, program code can be stored on any type of computer-readable medium, for example, such as a storage device including a disk or hard drive.

In addition, each block of the flowchart shown in FIG. 13 may represent circuitry that is wired to perform the specific logical functions in the process. Unless specifically indicated, functions in the flowchart shown in FIG. 13 may be executed out of order from that shown or discussed, including substantially concurrent execution of separately described functions, or even in reverse order in some examples, depending on the functionality involved, so long as the overall functionality of the described method is maintained.

Block 1302 includes spinning a plurality of reels on a display of a machine.

Block 1304 includes determining a plurality of re-spin costs corresponding to a plurality of re-spin combinations. Each re-spin combination includes a subset of the plurality of reels.

Block 1306 includes displaying, on the display of the machine, a first re-spin cost of the plurality of re-spin costs. The first re-spin cost will result from inclusion of a first reel in a selected combination of reels to re-spin or hold.

Block 1308 includes providing, on the display of the machine, an option to include the first reel in the selected combination of reels.

Block 1310 includes, responsive to receiving input data indicating to include the first reel in the selected combination of reels, displaying a second re-spin cost of the plurality of re-spin costs. The second re-spin cost will result from inclusion of a second reel in the selected combination of reels.

Block 1312 includes, responsive to receiving a re-spinning instruction, re-spinning the selected combination of reels on the display of the machine.

In some embodiments, determining the plurality of re-spin costs is performed after spinning the plurality of reels on the display of the machine.

In some embodiments, determining the plurality of re-spin costs is performed after a randomized reel position for each reel of the plurality of reels has been determined but before animation of the spinning of the plurality of reels is complete.

In some embodiments, determining the plurality of re-spin costs is performed before displaying the first re-spin cost.

In some embodiments, determining the plurality of re-spin costs includes requesting and receiving the plurality of re-spin costs from a server remote from the machine.

In some embodiments, the plurality of re-spin combinations represents each possible subset of reels from the plurality of reels.

In some embodiments, the plurality of re-spin costs are based on expected outcomes associated with re-spinning each of the plurality of re-spin combinations.

Some embodiments further include displaying, on the display of the machine, a re-spin cost associated with the selected combination of reels.

Some embodiments further include, after receiving the input data indicating to include the first reel in the selected combination of reels, providing, on the display of the machine, an option to remove the first reel from the selected combination of reels.

In some embodiments, the option to include the first reel includes a pair of check boxes. A first check box of the pair is associated with re-spinning the first reel. A second check box of the pair is associated with holding the first reel. Additionally, in some such embodiments, one check box of the pair is always selected, and selection of a check box of the pair removes selection of the other check box of the pair.

In some embodiments, the option to include the first reel is one of a plurality of options corresponding to the plurality of reels. In some such embodiments, the plurality of options make up a radio button array.

Some embodiments further include determining a suggested combination of reels for selection based on the determined plurality of re-spin costs, and causing the display of the machine to display an indication of the suggested combination of reels. In some such embodiments, the suggested combination of reels comprises at least two reels, and an option is provided, on the display of the machine, to simultaneously select each reel of the at least two reels. Additionally, an option may be provided on the display to enable automatic selection of the suggested combination of reels.

### IV. Additional Example Embodiments

The following enumerated example embodiments (EEEs) are offered as further description of the disclosed embodiments.

EEE 1 is a computer-implemented method comprising:

spinning a plurality of reels on a display of a machine;

determining a plurality of re-spin costs corresponding to a plurality of re-spin combinations, each re-spin combination comprising a subset of the plurality of reels;

displaying, on the display of the machine, a first re-spin cost of the plurality of re-spin costs, wherein the first re-spin cost will result from inclusion of a first reel in a selected combination of reels to re-spin or hold;

providing, on the display of the machine, an option to include the first reel in the selected combination of reels;

responsive to receiving input data indicating to include the first reel in the selected combination of reels, displaying a second re-spin cost of the plurality of re-spin costs, wherein the second re-spin cost will result from inclusion of a second reel in the selected combination of reels; and

responsive to receiving a re-spinning instruction, re-spinning the selected combination of reels on the display of the machine.

EEE 2 is the method of EEE 1, wherein determining the plurality of re-spin costs is performed after spinning the plurality of reels on the display of the machine.

EEE 3 is the method of EEE 1, wherein determining the plurality of re-spin costs is performed after a randomized reel position for each reel of the plurality of reels has been determined but before animation of the spinning of the plurality of reels is complete.

EEE 4 is the method of any of EEEs 1-3, wherein determining the plurality of re-spin costs is performed before displaying the first re-spin cost.

EEE 5 is the method of any of EEEs 1-4, wherein determining the plurality of re-spin costs comprises requesting and receiving the plurality of re-spin costs from a server remote from the machine.

EEE 6 is the method of any of EEEs 1-5, wherein the plurality of re-spin combinations represents each possible subset of reels from the plurality of reels.

EEE 7 is the method of any of EEEs 1-6, wherein the plurality of re-spin costs are based on expected outcomes associated with re-spinning each of the plurality of re-spin combinations.

EEE 8 is the method of any of EEEs 1-7, further comprising, displaying, on the display of the machine, a re-spin cost associated with the selected combination of reels.

EEE 9 is the method of any of EEEs 1-8, further comprising after receiving the input data indicating to include the first reel in the selected combination of reels, providing, on the display of the machine, an option to remove the first reel from the selected combination of reels.

EEE 10 is the method of any of EEEs 1-9, wherein the option to include the first reel comprises a pair of check boxes, wherein a first check box of the pair is associated with re-spinning the first reel, wherein a second check box of the pair is associated with holding the first reel.

EEE 11 is the method of EEE 10, wherein one check box of the pair is always selected, and wherein selection of a check box of the pair removes selection of the other check box of the pair.

EEE 12 is the method of any of EEEs 1-11, wherein the option to include the first reel is one of a plurality of options corresponding to the plurality of reels.

EEE 13 is the method of EEE 12, wherein the plurality of options make up a radio button array.

EEE 14 is the method of any of EEEs 1-13, further comprising:

determining a suggested combination of reels for selection based on the determined plurality of re-spin costs; and

causing the display of the machine to display an indication of the suggested combination of reels.

EEE 15 is the method of EEE 14, wherein the suggested combination of reels comprises at least two reels, and wherein the method further comprises providing, on the display of the machine, an option to simultaneously select each reel of the at least two reels.

EEE 16 is the method of EEE 14 or 15, further comprising providing, on the display of the machine, an option to enable automatic selection of the suggested combination of reels.

EEE 17 is an article of manufacture comprising non-transitory computer-readable medium, having stored thereon program instructions, that upon execution by at least one processor, cause a computing device to perform the operations of any of EEEs 1-16.

EEE 18 is a computing device comprising at least one processor, a memory component, and program instructions, stored in the memory component, that upon execution by the at least one processor, cause the computing device to perform the method of any one of EEEs 1-16.

EEE 19 is a system comprising means for carrying out the method of any of EEEs 1-16.

EEE 20 is a computer program comprising machine-readable instructions executable to cause a computing device to perform the method of any of EEEs 1-16.

### V. Conclusion

This detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be used, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including in substantially concurrent or in reverse order, depending on the functionality involved. Further, more or fewer steps, blocks and/or functions can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk or hard drive or other storage media.

The computer-readable medium can include non-transitory computer-readable media such as computer-readable media that stores data for short periods of time like register memory, processor cache, and/or random access memory (RAM). The computer-readable media can include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media can be any other volatile or non-volatile storage systems. A computer-readable medium can be considered a computer-readable storage medium, for example, or a tangible storage device.

Software for use in carrying out the invention can also be in transitory form, for example in the form of signals transmitted over a network such as the Internet. Moreover, a step or block that represents one or more information transmissions can correspond to information transmissions between software and/or hardware modules in the same physical device. However, other information transmissions can be between software modules and/or hardware modules in different physical devices.

Further, the described operations throughout this application need not be performed in the disclosed order, although in some examples, the recited order may be preferred. Also, not all operations need to be performed to achieve the desired advantages of disclosed machines and methods, and therefore not all operations are required.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

Thus, from one perspective, there has now been described a method which includes spinning a plurality of reels. The method further includes determining a plurality of re-spin costs corresponding to a plurality of re-spin combinations. The method additionally includes displaying a first re-spin cost of the plurality of re-spin costs, where the first re-spin cost will result from inclusion of a first reel in a selected combination of reels to re-spin or hold. The method also includes providing an option to include the first reel in the selected combination of reels. The method additionally includes, responsive to receiving input data indicating to include the first reel in the selected combination of reels, displaying a second re-spin cost of the plurality of re-spin costs, where the second re-spin cost will result from inclusion of a second reel in the selected combination of reels. The method also includes, responsive to receiving a re-spinning instruction, re-spinning the selected combination of reels.

1. A computer-implemented method comprising:
spinning a plurality of reels on a display of a machine;
determining a plurality of re-spin costs corresponding to a plurality of re-spin combinations, each re-spin combination comprising a subset of the plurality of reels;
displaying, on the display of the machine, a first re-spin cost of the plurality of re-spin costs, wherein the first re-spin cost will result from inclusion of a first reel in a selected combination of reels to re-spin or hold;
providing, on the display of the machine, an option to include the first reel in the selected combination of reels;
responsive to receiving input data indicating to include the first reel in the selected combination of reels, displaying a second re-spin cost of the plurality of re-spin costs, wherein the second re-spin cost will result from inclusion of a second reel in the selected combination of reels; and
responsive to receiving a re-spinning instruction, re-spinning the selected combination of reels on the display of the machine.

2. The method of claim 1, wherein determining the plurality of re-spin costs is performed after spinning the plurality of reels on the display of the machine.

3. The method of claim 1, wherein determining the plurality of re-spin costs is performed after a randomized reel position for each reel of the plurality of reels has been determined but before animation of the spinning of the plurality of reels is complete.

4. The method of claim 1, wherein determining the plurality of re-spin costs is performed before displaying the first re-spin cost.

5. The method of claim 1, wherein determining the plurality of re-spin costs comprises requesting and receiving the plurality of re-spin costs from a server remote from the machine.

6. The method of claim 1, wherein the plurality of re-spin combinations represents each possible subset of reels from the plurality of reels.

7. The method of claim 1, wherein the plurality of re-spin costs are based on expected outcomes associated with re-spinning each of the plurality of re-spin combinations.

8. The method of claim 1, further comprising, displaying, on the display of the machine, a re-spin cost associated with the selected combination of reels.

9. The method of claim 1, further comprising:
after receiving the input data indicating to include the first reel in the selected combination of reels, providing, on the display of the machine, an option to remove the first reel from the selected combination of reels.

10. The method of claim 1, wherein the option to include the first reel comprises a pair of check boxes, wherein a first check box of the pair is associated with re-spinning the first reel, wherein a second check box of the pair is associated with holding the first reel.

11. The method of claim 10, wherein one check box of the pair is always selected, and wherein selection of a check box of the pair removes selection of the other check box of the pair.

12. The method of claim 1, wherein the option to include the first reel is one of a plurality of options corresponding to the plurality of reels.

13. The method of claim 12, wherein the plurality of options make up a radio button array.

14. The method of claim 1, further comprising:
determining a suggested combination of reels for selection based on the determined plurality of re-spin costs; and
causing the display of the machine to display an indication of the suggested combination of reels.

15. The method of claim 14, wherein the suggested combination of reels comprises at least two reels, and wherein the method further comprises providing, on the display of the machine, an option to simultaneously select each reel of the at least two reels.

16. The method of claim 14, further comprising providing, on the display of the machine, an option to enable automatic selection of the suggested combination of reels.

17. A non-transitory computer-readable medium, having stored thereon program instructions, that upon execution by at least one processor, cause a computing device to perform the operations of:
spinning a plurality of reels on a display of a machine;
determining a plurality of re-spin costs corresponding to a plurality of re-spin combinations, each re-spin combination comprising a subset of the plurality of reels;
displaying, on the display of the machine, a first re-spin cost of the plurality of re-spin costs, wherein the first re-spin cost will result from inclusion of a first reel in a selected combination of reels to re-spin or hold;
providing, on the display of the machine, an option to include the first reel in the selected combination of reels;
responsive to receiving input data indicating to include the first reel in the selected combination of reels, displaying a second re-spin cost of the plurality of re-spin costs, wherein the second re-spin cost will result from inclusion of a second reel in the selected combination of reels; and
responsive to receiving a re-spinning instruction, re-spinning the selected combination of reels on the display of the machine.

18. A computing device comprising at least one processor, a memory component, and program instructions, stored in the memory component, that upon execution by the at least one processor, cause the computing device to perform the operations of:
spinning a plurality of reels on a display of a machine;
determining a plurality of re-spin costs corresponding to a plurality of re-spin combinations, each re-spin combination comprising a subset of the plurality of reels;
displaying, on the display of the machine, a first re-spin cost of the plurality of re-spin costs, wherein the first re-spin cost will result from inclusion of a first reel in a selected combination of reels to re-spin or hold;
providing, on the display of the machine, an option to include the first reel in the selected combination of reels;
responsive to receiving input data indicating to include the first reel in the selected combination of reels, displaying a second re-spin cost of the plurality of re-spin costs, wherein the second re-spin cost will result from inclusion of a second reel in the selected combination of reels; and
responsive to receiving a re-spinning instruction, re-spinning the selected combination of reels on the display of the machine.

19. (canceled)

20. (canceled)
